(19) United States
(12) Patent Application Publication
(10) Pub. No.: US 2019/0092316 A1
(43) Pub. Date: Mar. 28, 2019

(54) VEHICLE DRIVE DEVICE AND ELECTRIC VEHICLE

(71) Applicant: Panasonic Intellectual Property Management Co., Ltd., Osaka (JP)

(72) Inventor: JUNICHI YUKAWA, Kanagawa (JP)

(21) Appl. No.: 16/087,009

(22) PCT Filed: Feb. 13, 2017
(86) PCT No.: PCT/JP2017/005039

§ 371 Date: Sep. 20, 2018

(30) Foreign Application Priority Data
Mar. 30, 2016 (JP) 2016-068860

(51) Int. Cl. B60W 20/40; B60K 6/26; B60K 6/40; B60K 6/387; B60K 6/28; B60K 6/42; B60W 30/188; H02P 5/74; H02J 7/14

(52) U.S. Cl. CPC B60W 20/40; B60K 6/26; B60K 6/40; B60K 6/387; B60K 6/28; H02J 2007/143; B60W 30/188; H02P 5/74; H02J 7/1423; B60Y 2200/92; B60K 6/42

(57) ABSTRACT

A second motor is connected to a shaft. A power transmission mechanism is configured to transmit power from the shaft and power from a second motor to a driving wheel. A power switching mechanism is connected to a first motor, the shaft, and an internal combustion engine. The power switching mechanism is switchable to a first state in which power transmission between the first motor and the shaft is allowed, a second state in which power transmission between the first motor and the shaft is inhibited and power transmission between the first motor and the internal combustion engine is inhibited, and a third state in which power transmission between the first motor and the internal combustion engine is allowed.

### TECHNICAL FIELD

The present disclosure relates to a vehicle drive device and an electric vehicle.

### BACKGROUND ART

Electrically driven vehicles have been conventionally known. Such conventional electrically driven vehicle is disclosed in Unexamined Japanese Patent Publication No. 2008-79420 (PTL 1), for example. PTL 1 discloses an electrically driven vehicle including an induction motor connected to a first wheel, a synchronous motor connected to a second wheel, and a motor control means connected to the induction motor and the synchronous motor for supplying a drive current to the induction motor and the synchronous motor. In this electrically driven vehicle, the synchronous motor is driven as a main drive source when the vehicle travels, and the induction motor is driven as an auxiliary drive source when the vehicle starts moving or accelerates.

### CITATION LIST

### Patent Literature

PTL 1: Unexamined Japanese Patent Publication No. 2008-79420

### SUMMARY OF THE INVENTION

Recently, attention has been focused on an electrically driven vehicle (so-called range extender) including an emergency generator and an internal combustion engine for driving the generator, in addition to a driving motor. In the range extender, when a remaining amount of a battery of the electrically driven vehicle is less than a predetermined amount, the internal combustion engine is driven to generate electric power from the emergency generator and the driving motor is driven with the electric power generated from the emergency generator. Thus, the cruising range of the electrically driven vehicle can be extended.

The present disclosure relates to a vehicle drive device that drives a driving wheel of an electric vehicle provided with an internal combustion engine, the vehicle drive device including a shaft, a first motor, a second motor, a power transmission mechanism, and a power switching mechanism.

The second motor is connected to the shaft. The power transmission mechanism is configured to transmit power from the shaft and power from the second motor to the driving wheel. The power switching mechanism is connected to the first motor, the shaft, and the internal combustion engine, and is switchable to a first state, a second state, and a third state. In the first state, power transmission between the first motor and the shaft is allowed, while power transmission between the first motor and the internal combustion engine is inhibited. In the second state, power transmission between the first motor and the shaft is inhibited and power transmission between the first motor and the internal combustion engine is inhibited. In the third state, power transmission between the first motor and the internal combustion engine is allowed, while power transmission between the first motor and the shaft is inhibited.

According to this disclosure, the first motor can be used for both driving and power generation by switching the state of the power switching mechanism. Accordingly, the vehicle drive device can be downsized, as compared to a configuration in which a generator for generating power is provided in addition to two driving motors (that is, a configuration having three rotary electric machines).

### BRIEF DESCRIPTION OF DRAWINGS

FIG. 1 is a diagram schematically illustrating a configuration of an electric vehicle according to an exemplary embodiment.

FIG. 2 is a schematic configuration diagram for describing a second state of a power switching mechanism.

FIG. 3 is a schematic configuration diagram for describing a third state of the power switching mechanism.

FIG. 4 is a block diagram for describing a control unit.

FIG. 5 is a graph illustrating power characteristics of a first motor.

FIG. 6 is a graph illustrating torque-rotational speed characteristics and electromotive voltage characteristics of the first motor.

FIG. 7 is a graph illustrating power characteristics of a second motor (magnetless motor).

FIG. 8 is a graph illustrating power characteristics of the first and second motors.

FIG. 9 is a graph illustrating power characteristics of a second motor (permanent magnet motor).

FIG. 10 is a graph illustrating power characteristics of a motor in a comparative example.

### DESCRIPTION OF EMBODIMENT

Prior to describing an exemplary embodiment of the present disclosure, problems of the conventional device will be briefly described. It is considered that, in addition to two existing driving motors, an emergency generator and an internal combustion engine for driving the generator are provided to the electrically driven vehicle disclosed in PTL 1. However, when such a configuration is applied, the electrically driven vehicle includes three rotary electric machines (motors/generator), which makes it difficult to downsize a device (vehicle drive device) for driving wheels of the electrically driven vehicle.

Hereinafter, the exemplary embodiment will be described in detail with reference to the drawings. Note that identical or equivalent parts are given identical reference signs, and the description of such parts will not be repeated.

### [Electric Vehicle]

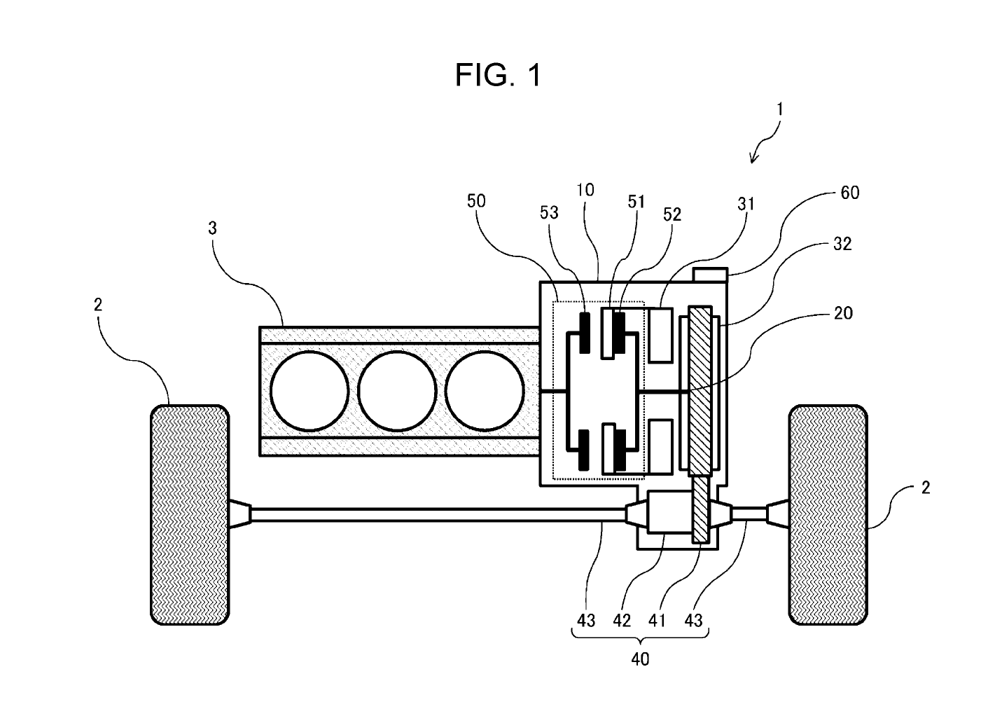

FIG. 1 illustrates an example of a configuration of electric vehicle 1 according to the exemplary embodiment. Electric vehicle 1 includes driving wheels 2, internal combustion engine 3, and vehicle drive device 10. Vehicle drive device 10 is mechanically connected to internal combustion engine 3 to drive driving wheels 2. Electric vehicle 1 configures what is called a range extender. Specifically, vehicle drive device 10 includes shaft 20, first motor 31, second motor 32, power transmission mechanism 40, power switching mechanism 50, and control unit 60.

### <Internal Combustion Engine>

Internal combustion engine 3 is configured to convert heat energy into rotational energy. Specifically, when a fuel is combusted in a cylinder (not illustrated) of internal combustion engine 3, a piston (not illustrated) of internal combustion engine 3 is driven, and a drive shaft of internal combustion engine 3 rotates. Power of internal combustion engine 3 is not set to be capable of independently driving driving wheels 2, but is set to be capable of independently causing first motor 31 to generate power. That is, internal combustion engine 3 cannot generate power that can independently drive driving wheels 2, but can generate power that can independently cause first motor 31 to generate power. Therefore, internal combustion engine 3 can be made compact, as compared to a configuration in which internal combustion engine 3 can independently drive driving wheels 2.

### <First Motor>

First motor 31 is configured to convert electric energy into rotational energy. First motor 31 also has a function (a function of a generator) for converting rotational energy into electric energy. In other words, first motor 31 can be set to a state (drive state) in which electric energy is converted into rotational energy and a state (power generation state) in which rotational energy is converted into electric energy. Specifically, when electric power is supplied to a stator (not illustrated) of first motor 31, a rotor (not illustrated) of first motor 31 rotates, and when rotational force is applied to the rotor of first motor 31, electric power is generated in the stator of first motor 31.

First motor 31 is a low-speed motor configured to be capable of generating power corresponding to a medium-to-low speed low-load travel state of electric vehicle 1. Specifically, the low-speed motor (first motor 31) is configured to have a relatively low output and to be capable of generating power (or power slightly smaller than power to be required) necessary for electric vehicle 1 to travel in the medium-to-low speed low-load travel state. The low-speed motor (first motor 31) is also configured to have relatively high efficiency in a low-output region corresponding to the medium-to-low speed low-load travel state of electric vehicle 1. The medium-to-low speed low-load travel state and the low-output region will be described later in detail.

In the present exemplary embodiment, first motor 31 is configured with a permanent magnet motor.

In the present exemplary embodiment, first motor 31 has a ring shape, and shaft 20 passes through its central opening. Note that first motor 31 is not limited to have the shape described above, and may have a cylindrical shape or disk shape.

### <Second Motor>

Second motor 32 is configured to convert electric energy into rotational energy. Second motor 32 also has a function (a function of a generator) for converting rotational energy into electric energy. In other words, second motor 32 can be set to a state (drive state) in which electric energy is converted into rotational energy and a state (power generation state) in which rotational energy is converted into electric energy. Specifically, when electric power is supplied to a stator (not illustrated) of second motor 32, a rotor (not illustrated) of second motor 32 rotates, and when rotational force is applied to the rotor of second motor 32, electric power is generated in the stator of second motor 32.

Second motor 32 is connected to shaft 20. In the present exemplary embodiment, second motor 32 is configured to transmit power to later-described gear 41 (gear 41 connected to shaft 20). When second motor 32 rotates, the rotational force of second motor 32 is transmitted to shaft 20 via gear 41 (a part of power transmission mechanism 40). Further, when shaft 20 rotates, the rotational force of shaft 20 is transmitted to second motor 32 via gear 41 (a part of power transmission mechanism 40).

Second motor 32 is a high-speed motor configured to be capable of generating power corresponding to a high-speed travel state of electric vehicle 1. Specifically, the high-speed motor (second motor 32) is configured to have a relatively high output and to be capable of generating power necessary for electric vehicle 1 to travel in the high-speed travel state. The high-speed motor (second motor 32) is also configured to have relatively high efficiency in a high-output region corresponding to the high-speed travel state of electric vehicle 1. The high-speed travel state and the high-output region will be described later in detail.

In the present exemplary embodiment, second motor 32 is configured with a magnetless motor that does not have a permanent magnet. Examples of the magnetless motors include induction motors, switched reluctance motors, and synchronous reluctance motors.

In the present exemplary embodiment, second motor 32 is formed into a disk shape. Gear 41 (a part of power transmission mechanism 40) is disposed on the outer circumference of second motor 32, and power of second motor 32 is transmitted to gear 41. Note that second motor 32 is not limited to have the shape described above, and may have a cylindrical shape.

### <Power Transmission Mechanism>

Power transmission mechanism 40 transmits power from shaft 20 and power from second motor 32 to driving wheels 2. In the present exemplary embodiment, power transmission mechanism 40 includes gear 41, differential mechanism 42, and drive shaft 43. Gear 41 is connected to shaft 20. Differential mechanism 42 is mechanically connected to drive shaft 43 so as to transmit power from gear 41 to drive shaft 43. Drive shaft 43 is connected to driving wheels 2 at both ends. When shaft 20 and second motor 32 rotate, the rotational force of shaft 20 and second motor 32 is transmitted to driving wheels 2 via gear 41, differential mechanism 42, and drive shaft 43 in order, whereby driving wheels 2 rotate. Further, when driving wheels 2 rotate, the rotational force of driving wheels 2 is transmitted to shaft 20 and second motor 32 via drive shaft 43, differential mechanism 42, and gear 41 in order. That is, power transmission mechanism 40 is configured to transmit power between driving wheels 2 and both shaft 20 and second motor 32.

In the present exemplary embodiment, gear 41 is disposed on the outer circumference of second motor 32 to receive power from second motor 32. Gear 41 is not limited to have the configuration described above, and may be configured to mesh with a gear connected to a drive shaft of second motor 32 having a cylindrical shape. In such a configuration, second motor 32 can also be linked to shaft 20, whereby power transmission mechanism 40 can transmit power from shaft 20 and power from second motor 32 to driving wheels 2.

### <Power Switching Mechanism>

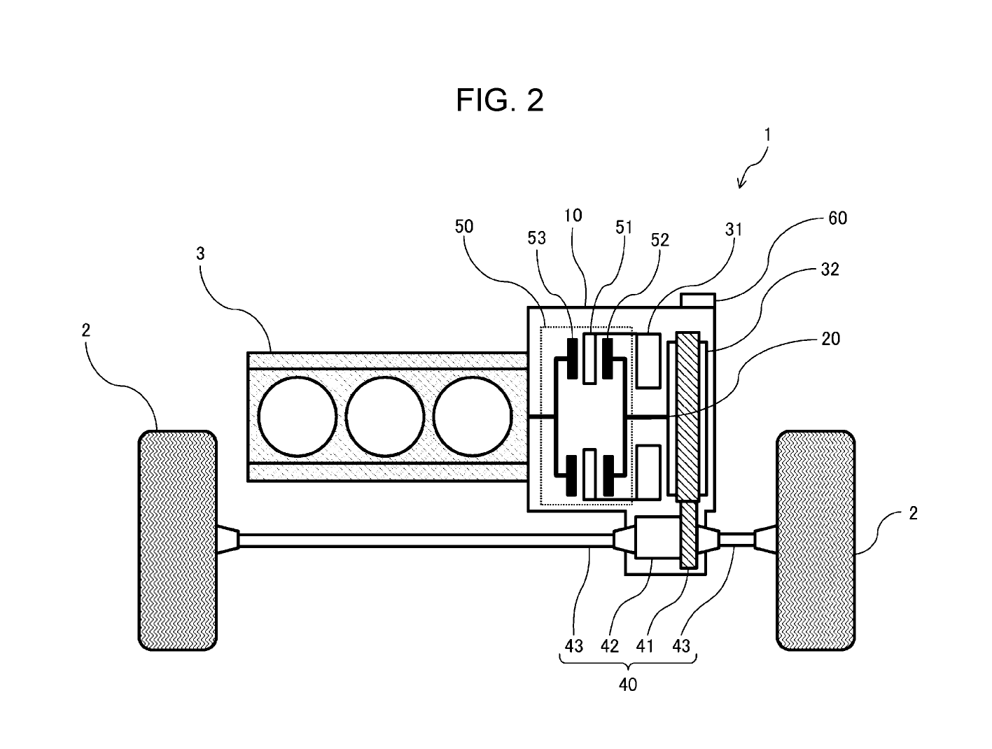

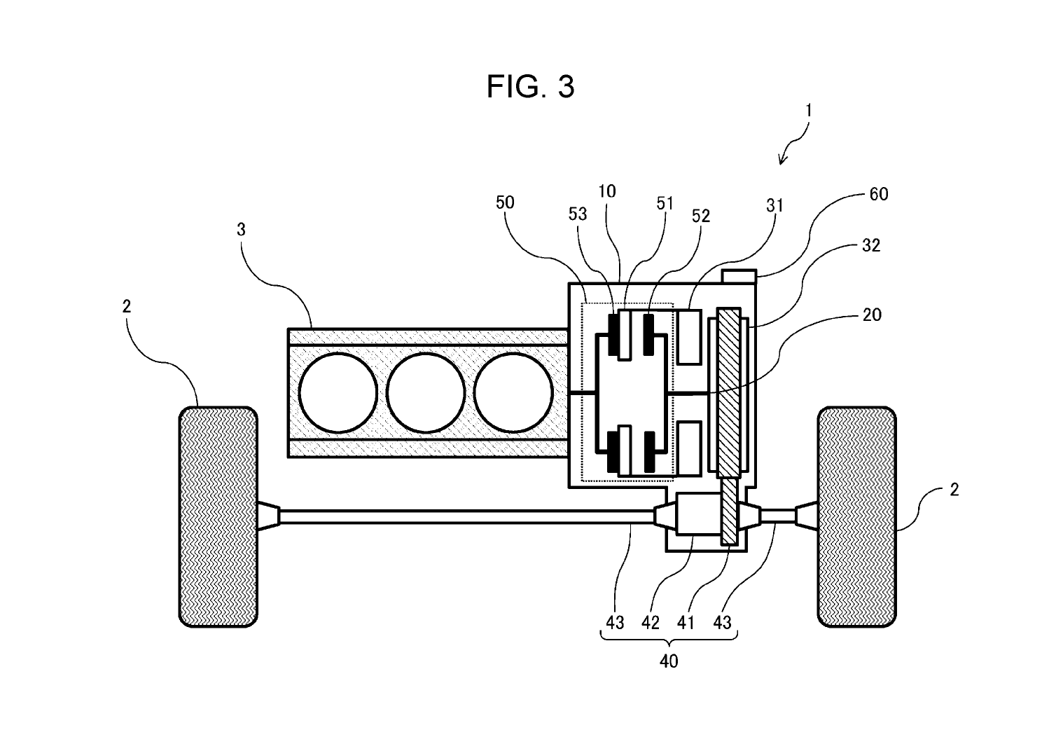

Power switching mechanism 50 is connected to first motor 31, shaft 20, and internal combustion engine 3, and is switchable to a first state, a second state, and a third state. In the first state (state illustrated in FIG. 1), power transmission mechanism 40 allows power transmission between first motor 31 and shaft 20, while inhibits power transmission between first motor 31 and internal combustion engine 3. In the second state (state illustrated in FIG. 2), power transmission mechanism 40 inhibits power transmission between first motor 31 and shaft 20 and inhibits power transmission between first motor 31 and internal combustion engine 3. In the third state (state illustrated in FIG. 3), power switching mechanism 50 allows power transmission between first motor 31 and internal combustion engine 3, while inhibits power transmission between first motor 31 and shaft 20.

In the present exemplary embodiment, power switching mechanism 50 includes first clutch member 51, second clutch member 52, and third clutch member 53. First clutch member 51 is connected to first motor 31, second clutch member 52 is connected to shaft 20, and third clutch member 53 is connected to the drive shaft of internal combustion engine 3. In the first state, first clutch member 51 is engaged with second clutch member 52, while disengaged from third clutch member 53. With this, power is transmitted between first motor 31 and shaft 20, while power is not transmitted between first motor 31 and internal combustion engine 3. In the second state, first clutch member 51 is disengaged from both second clutch member 52 and third clutch member 53. With this, power is not transmitted between first motor 31 and shaft 20, and power is not transmitted between first motor 31 and internal combustion engine 3. In the third state, first clutch member 51 is engaged with third clutch member 53, while disengaged from second clutch member 52. With this, power is transmitted between first motor 31 and internal combustion engine 3, while power is not transmitted between first motor 31 and shaft 20.

### <Control Unit>

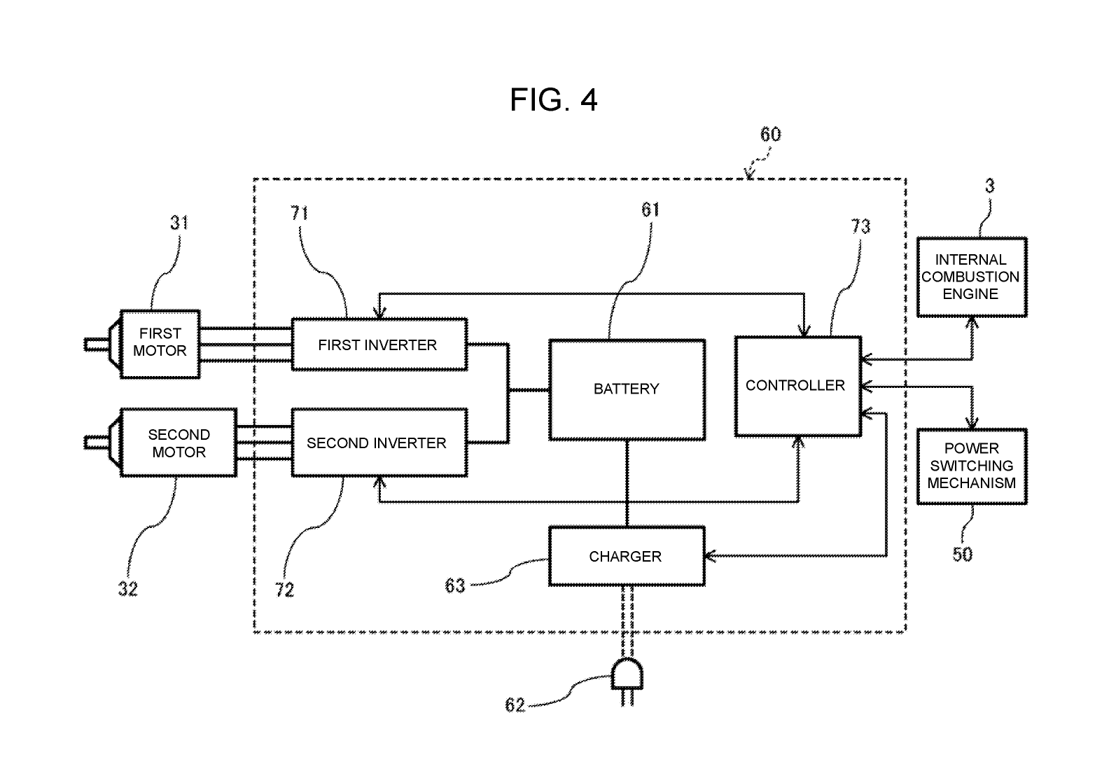

Control unit 60 is configured to control first motor 31, second motor 32, internal combustion engine 3, and power switching mechanism 50. In the present exemplary embodiment, control unit 60 includes battery 61, plug 62, charger 63, first inverter 71, second inverter 72, and controller 73, as illustrated in FIG. 4.

### «Battery, Plug, and Charger»

Battery 61 stores electric power. Battery 61, first inverter 71, and second inverter 72 are electrically connected to one another. Plug 62 is connectable to an external power source (not illustrated). Charger 63 is electrically connected to battery 61 and plug 62, and stores electric power supplied from the external power source via plug 62 into battery 61 in response to control with controller 73.

### «First Inverter»

First inverter 71 is electrically connected to first motor 31. First inverter 71 converts electric power (for example, electric power from battery 61) supplied to first inverter 71 into desired first output electric power by a switching operation, and supplies the first output electric power to first motor 31. First inverter 71 is a low-speed motor inverter configured to supply the first output electric power suitable for first motor 31 serving as a low-speed motor. Specifically, first inverter 71 (low-speed motor inverter) is configured to have a relatively low output, and supplies the first output electric power such that first motor 31 (low-speed motor) is driven in the low-output region corresponding to the medium-to-low speed low-load travel state of electric vehicle 1.

### «Second Inverter»

Second inverter 72 is electrically connected to second motor 32. Second inverter 72 converts electric power (for example, electric power from battery 61 or electric power from first motor 31) supplied to second inverter 72 into desired second output electric power by a switching operation, and supplies the second output electric power to second motor 32. Second inverter 72 is a high-speed motor inverter configured to supply the second output electric power suitable for second motor 32 serving as a high-speed motor. Specifically, second inverter 72 (high-speed motor inverter) is configured to have a relatively high output, and supplies the second output electric power such that second motor 32 (high-speed motor) is driven in the high-output region corresponding to the high-speed travel state of electric vehicle 1.

### «Controller»

Controller 73 controls respective components (specifically, internal combustion engine 3, charger 63, first inverter 71, and second inverter 72) of electric vehicle 1 based on detection values of various sensors provided to respective components of electric vehicle 1. In the present exemplary embodiment, controller 73 is configured with an electronic control unit (ECU), and includes a computing processor such as a central processing unit (CPU) and a memory (storage unit) that stores programs and information for operating the computing processor. Examples of various sensors include a rotational speed sensor that detects a rotational speed of each component such as driving wheels 2, first motor 31, second motor 32, or internal combustion engine 3, a current sensor that detects a current value of each component such as first motor 31 or second motor 32, and a power sensor that detects a remaining amount of electric power stored in battery 61 (such sensors are not illustrated).

<Operation with Control Unit>

Operations with control unit 60 (controller 73) will now be described. Control unit 60 performs following operations in the medium-to-low speed low-load travel state, medium-to-low speed high-load travel state, high-speed travel state, emergency travel state, and deceleration regenerative travel state, respectively. The medium-to-low speed low-load travel state indicates a travel state (so-called city driving) in which the rotational speed of driving wheels 2 is less than or equal to a predetermined rotational speed threshold (for example, rotational speed corresponding to 40 km/h) and the load of driving wheels 2 is less than or equal to a predetermined load threshold (for example, a load value corresponding to a maximum driving force that can be generated by first motor 31). The medium-to-low speed high-load travel state indicates a travel state in which the rotational speed of driving wheels 2 is less than or equal to the rotational speed threshold and the load of driving wheels 2 exceeds the load threshold. The high-speed travel state indicates a travel state in which the rotational speed of driving wheels 2 exceeds the rotational speed threshold. The emergency travel state indicates a state in which electric vehicle 1 is driven with the remaining amount of electric power stored in battery 61 being less than a predetermined remaining amount threshold (for example, 20% of the maximum storage capacity). The deceleration regenerative travel state indicates a travel state in which the motor (at least one of first motor 31 and second motor 32) is caused to generate electric power with the rotational force of driving wheels 2 while electric vehicle 1 decelerates, and the generated electric power is stored in battery 61.

### «Meclium-To-Low Speed Low-Load Travel State»

When the rotational speed of driving wheels 2 is less than or equal to the rotational speed threshold and the load of driving wheels 2 is less than or equal to the load threshold (that is, in the medium-to-low speed low-load travel state), control unit 60 sets power switching mechanism 50 to the first state (state illustrated in FIG. 1), sets first motor 31 to a drive state, and sets second motor 32 and internal combustion engine 3 to a stopped state.

Specifically, controller 73 controls first inverter 71 such that electric power is supplied to first motor 31 from battery 61 via first inverter 71, thereby setting first motor 31 to the drive state. Controller 73 also controls second inverter 72 such that electric power is not supplied to second motor 32 from battery 61 via second inverter 72, thereby setting second motor 32 to the stopped state.

In the medium-to-low speed low-load travel state (that is, in the travel state where the rotational speed of driving wheels 2 is less than or equal to the rotational speed threshold and the load of driving wheels 2 is less than or equal to the load threshold), power switching mechanism 50 is set to the first state, first motor 31 is set to the drive state, and second motor 32 and internal combustion engine 3 are set to the stopped state. Accordingly, power (rotational force) of first motor 31 is transmitted to driving wheels 2 via power switching mechanism 50, shaft 20, and power transmission mechanism 40 in order, whereby driving wheels 2 are rotationally driven by the power from first motor 31.

In this way, in the medium-to-low speed low-load travel state, driving wheels 2 can be driven with the power from first motor 31.

### «Medium-To-Low Speed High-Load Travel State»

When the rotational speed of driving wheels 2 is less than or equal to the rotational speed threshold and the load of driving wheels 2 exceeds the load threshold (that is, in the medium-to-low speed high-load travel state), control unit 60 sets power switching mechanism 50 to the first state (state illustrated in FIG. 1), sets first motor 31 and second motor 32 to the drive state, and sets internal combustion engine 3 to the stopped state.

Specifically, controller 73 controls first inverter 71 and second inverter 72 such that electric power is supplied to first motor 31 and second motor 32 from battery 61 via first inverter 71 and second inverter 72. Thus, first motor 31 and second motor 32 are set to the drive state.

In the medium-to-low speed high-load travel state (that is, in the travel state where the rotational speed of driving wheels 2 is less than or equal to the rotational speed threshold and the load of driving wheels 2 exceeds the load threshold), power switching mechanism 50 is set to the first state, first motor 31 and second motor 32 are set to the drive state, and internal combustion engine 3 is set to the stopped state. Accordingly, power (rotational force) of first motor 31 is transmitted to driving wheels 2 via power switching mechanism 50, shaft 20, and power transmission mechanism 40 in order, whereby driving wheels 2 are rotationally driven by the power from first motor 31. In addition, power (rotational force) from second motor 32 is transmitted to driving wheels 2 via power transmission mechanism 40, whereby the drive of driving wheels 2 is assisted by the power from second motor 32.

In this way, in the medium-to-low speed high-load travel state, driving wheels 2 can be driven with the power from first motor 31, and the drive of driving wheels 2 can be assisted by the power from second motor 32.

### «High-Speed Travel State»

When the rotational speed of driving wheels 2 exceeds the rotational speed threshold (that is, in the high-speed travel state), control unit 60 sets power switching mechanism 50 to the second state (state illustrated in FIG. 2), sets second motor 32 to the drive state, and sets first motor 31 and internal combustion engine 3 to the stopped state.

Specifically, controller 73 controls second inverter 72 such that electric power is supplied to second motor 32 from battery 61 via second inverter 72, thereby setting second motor 32 to the drive state. Controller 73 also controls first inverter 71 such that electric power is not supplied to first motor 31 from battery 61 via first inverter 71, thereby setting first motor 31 to the stopped state.

In the high-speed travel state (that is, in the travel state where the rotational speed of driving wheels 2 exceeds the rotational speed threshold), power switching mechanism 50 is set to the second state, second motor 32 is set to the drive state, and first motor 31 and internal combustion engine 3 are set to the stopped state. Thus, power (rotational force) from second motor 32 is transmitted to driving wheels 2 via power transmission mechanism 40, whereby driving wheels 2 are rotationally driven by the power from second motor 32.

In this way, in the high-speed travel state, driving wheels 2 can be driven with the power from second motor 32.

### «Emergency Travel State»

When the remaining amount of electric power stored in battery 61 is less than the remaining amount threshold (that is, in the emergency travel state), control unit 60 sets power switching mechanism 50 to the third state (state illustrated in FIG. 3), sets internal combustion engine 3 to the drive state, and sets second motor 32 to the drive state with the electric power generated from first motor 31.

Specifically, controller 73 firstly controls first inverter 71 such that electric power stored in battery 61 is supplied to first motor 31 via first inverter 71, thereby setting first motor 31 to the drive state. Then, controller 73 starts internal combustion engine 3 with the power from first motor 31, thereby setting internal combustion engine 3 to the drive state. When internal combustion engine 3 is set to the drive state, controller 73 controls first inverter 71 such that the supply of electric power from battery 61 to first motor 31 is stopped. Thus, first motor 31 is driven to generate electric power with the power from internal combustion engine 3. Then, controller 73 controls first inverter 71 and second inverter 72 such that electric power generated from first motor 31 is supplied to second motor 32 via first inverter 71 and second inverter 72 in order, thereby setting second motor 32 to the drive state.

In the present exemplary embodiment, control unit 60 is configured to store, into battery 61, surplus electric power, which is not used for driving second motor 32, of the electric power generated from first motor 31. Specifically, controller 73 controls first inverter 71 and second inverter 72 such that a portion of the electric power generated from first motor 31 is supplied to second motor 32 via first inverter 71 and second inverter 72 in order and the rest of the electric power generated from first motor 31 is supplied to battery 61 via first inverter 71. In this way, controller 73 sets second motor 32 to the drive state and stores the surplus electric power into battery 61.

In the emergency travel state (that is, when electric vehicle 1 is driven with the remaining amount of electric power stored in battery 61 being less than the remaining amount threshold), power switching mechanism 50 is set to the third state, and internal combustion engine 3 is set to the drive state. Thus, the power (rotational force) from internal combustion engine 3 is transmitted to first motor 31 via power switching mechanism 50, whereby first motor 31 is driven with the power from internal combustion engine 3 to generate electric power. Then, second motor 32 is set to the drive state with the electric power generated from first motor 31. Specifically, the electric power from first motor 31 is supplied to second motor 32 via first inverter 71 and second inverter 72, whereby second motor 32 is rotationally driven with the electric power from first motor 31. Then, power (rotational force) from second motor 32 is transmitted to driving wheels 2 via power transmission mechanism 40, whereby driving wheels 2 are rotationally driven by the power from second motor 32. Further, the surplus electric power, which is not used for driving second motor 32, of the electric power from first motor 31 is supplied to battery 61 and stored therein.

In this way, in the emergency travel state, second motor 32 can be driven with the electric power generated from first motor 31, and driving wheels 2 can be driven with the power from second motor 32. Further, the surplus electric power, which is not used for driving second motor 32, of the electric power generated from first motor 31 can be stored into battery 61.

### «Deceleration Regenerative Travel State»

When electric vehicle 1 decelerates (that is, in the deceleration regenerative travel state), control unit 60 sets power switching mechanism 50 to the first state (state illustrated in FIG. 1), sets at least one of first motor 31 and second motor 32 to a power generation state, sets internal combustion engine 3 to the stopped state, and stores regenerative electric power generated from at least one of first motor 31 and second motor 32 into battery 61.

Specifically, controller 73 determines whether electric vehicle 1 is decelerating based on a change in the rotational speed of driving wheels 2, and when determining that electric vehicle 1 is now decelerating, sets power switching mechanism 50 to the first state. Then, controller 73 obtains a regenerative braking amount according to a deceleration (specifically, an amount of depression of a brake pedal (not illustrated) of electric vehicle 1) of electric vehicle 1. Controller 73 controls at least one of first inverter 71 and second inverter 72 such that the regenerative braking amount is obtained, thereby causing at least one of first motor 31 and second motor 32 to generate electric power. Controller 73 may be configured to determine which one of first motor 31 and second motor 32 is caused to generate electric power according to the rotational speed of driving wheels 2 or the regenerative braking amount.

In the deceleration regenerative travel state (that is, when electric vehicle 1 is decelerated while generating electric power), power switching mechanism 50 is set to the first state, at least one of first motor 31 and second motor 32 is set to the power generation state, and internal combustion engine 3 is set to the stopped state. With this, the rotational force of driving wheels 2 is transmitted to shaft 20 and second motor 32 via power transmission mechanism 40, whereby second motor 32 rotates. Further, the power from shaft 20 is transmitted to first motor 31 via power switching mechanism 50, whereby first motor 31 rotates. One of first motor 31 and second motor 32 which is set to the power generation state generates electric power, and the generated electric power (regenerative electric power) is stored in battery 61.

### «Non-Acceleration Travel State 1»

When electric vehicle 1 relatively slowly decelerates (that is, in a non-acceleration travel state), control unit 60 sets power switching mechanism 50 to the second state (state illustrated in FIG. 2) and sets first motor 31, second motor 32, and internal combustion engine 3 to the stopped state. When electric vehicle 1 relatively suddenly decelerates (for example, when the brake pedal of electric vehicle 1 is depressed), control unit 60 sets power switching mechanism 50 to the first state (state illustrated in FIG. 1), sets at least one of first motor 31 and second motor 32 to the power generation state, and sets internal combustion engine 3 to the stopped state. In this way, regenerative electric power generated from at least one of first motor 31 and second motor 32 may be stored into battery 61. The non-acceleration travel state indicates a travel state in which electric vehicle 1 slowly decelerates. Specifically, the non-acceleration travel state indicates a travel state in which neither an accelerator pedal nor the brake pedal (both pedals are not illustrated) of electric vehicle 1 is depressed and the deceleration of electric vehicle 1 is less than a predetermined deceleration threshold.

With the above configuration, while electric vehicle 1 travels in the non-acceleration travel state, a coasting distance of electric vehicle 1 can be extended with the power generation of first motor 31 and second motor 32 being suppressed.

### «Non-Acceleration Travel State 2»

When electric vehicle 1 relatively slowly decelerates, control unit 60 sets power switching mechanism 50 to the first state (state illustrated in FIG. 1) or second state (state illustrated in FIG. 2) and sets first motor 31, second motor 32, and internal combustion engine 3 to the stopped state. When electric vehicle 1 relatively suddenly decelerates, control unit 60 sets power switching mechanism 50 to the first state (state illustrated in FIG. 1), sets at least one of first motor 31 and second motor 32 to the power generation state, and sets internal combustion engine 3 to the stopped state. In this way, regenerative electric power generated from at least one of first motor 31 and second motor 32 may be stored into battery 61.

Specifically, control unit 60 performs a first non-acceleration travel operation until a predetermined waiting time (for example, several seconds) has elapsed from a point at which the accelerator pedal of electric vehicle 1 is released and electric vehicle 1 shifts to the non-acceleration travel state (that is, the travel state where neither the accelerator pedal nor the brake pedal of electric vehicle 1 is depressed and the deceleration of electric vehicle 1 is less than the deceleration threshold) while electric vehicle 1 travels in the medium-to-low speed travel state (medium-to-low speed low-load travel state or medium-to-low speed high-load travel state). Further, control unit 60 may be configured to perform a second non-acceleration travel operation after the waiting time has elapsed from the point at which electric vehicle 1 shifts to the non-acceleration travel state while traveling in the medium-to-low speed travel state, and to perform a deceleration regenerative travel operation when the brake pedal of electric vehicle 1 is depressed while electric vehicle 1 travels in the non-acceleration travel state. The first non-acceleration travel operation means an operation for setting power switching mechanism 50 to the first state (state illustrated in FIG. 1) and setting first motor 31, second motor 32, and internal combustion engine 3 to the stopped state. The second non-acceleration travel operation means an operation for setting power switching mechanism 50 to the second state (state illustrated in FIG. 2) and setting first motor 31, second motor 32, and internal combustion engine 3 to the stopped state. The deceleration regenerative travel operation means an operation for setting power switching mechanism 50 to the first state, setting at least one of first motor 31 and second motor 32 to a power generation state, setting internal combustion engine 3 to the stopped state, and storing regenerative electric power generated from at least one of first motor 31 and second motor 32 into battery 61.

As described above, while traveling in the non-acceleration travel state, electric vehicle 1 performs the second non-acceleration travel operation (operation for setting power switching mechanism 50 to the second state and setting first motor 31, second motor 32, and internal combustion engine 3 to the stopped state). With the above configuration, a coasting distance of electric vehicle 1 can be extended with the power generation of first motor 31 and second motor 32 being suppressed.

If the driver lifts his/her foot from the accelerator pedal and depresses the brake pedal while electric vehicle 1 travels in the medium-to-low speed travel state (medium-to-low speed low-load travel state or medium-to-low speed high-load travel state), electric vehicle 1 sequentially shifts to the medium-to-low speed travel state, non-acceleration travel state, and deceleration regenerative travel state in a short period. Therefore, in the configuration in which control unit 60 is configured to perform the second non-acceleration travel operation just after electric vehicle 1 shifts to the non-acceleration travel state while traveling in the medium-to-low speed travel state, when the driver lifts his/her foot from the accelerator pedal and depresses the brake pedal while electric vehicle 1 travels in the medium-to-low speed travel state, power switching mechanism 50 is switched to the second state from the first state, and then, immediately switched to the first state again. When power switching mechanism 50 is frequently switched in a short period as described above, electric vehicle 1 may receive a shock.

In view of this, the first non-acceleration travel operation is performed from a point at which electric vehicle 1 shifts to the non-acceleration travel state while traveling in the medium-to-low speed travel state until a waiting time (specifically, a time longer than a time required for the driver to lift his/her foot from the accelerator pedal and depress the brake pedal) has elapsed, and the second non-acceleration travel operation is performed after the waiting time has elapsed from the point at which electric vehicle 1 shifts to the non-acceleration travel state. This configuration can prevent the state of power switching mechanism 50 from being frequently switched (specifically, prevent that the state of power switching mechanism 50 is frequently switched due to the operation of the driver lifting his/her foot from the accelerator pedal and depressing the brake pedal while electric vehicle 1 travels in the medium-to-low speed travel state).

### [Effects of Exemplary Embodiment]

As described above, vehicle drive device 10 according to the present exemplary embodiment sets power switching mechanism 50 to the first state (state illustrated in FIG. 1), thereby being capable of driving driving wheels 2 with power from first motor 31 and power from second motor 32. Further, vehicle drive device 10 sets power switching mechanism 50 to the second state (state illustrated in FIG. 2), thereby being capable of driving driving wheels 2 with power from second motor 32. Moreover, vehicle drive device 10 sets power switching mechanism 50 to the third state (state illustrated in FIG. 3), thereby being capable of causing first motor 31 to generate electric power with power from internal combustion engine 3. Due to the switching of the state of power switching mechanism 50 in this way, first motor 31 can be used for both driving and power generation, whereby vehicle drive device 10 can be downsized, as compared to a configuration in which a generator for power generation is provided in addition to two driving motors (that is, three rotary electric machines are provided). Accordingly, a space occupied by vehicle drive device 10 in electric vehicle 1 can be reduced, whereby the internal space of electric vehicle 1 can be effectively used.

### [Power Characteristics of First Motor]

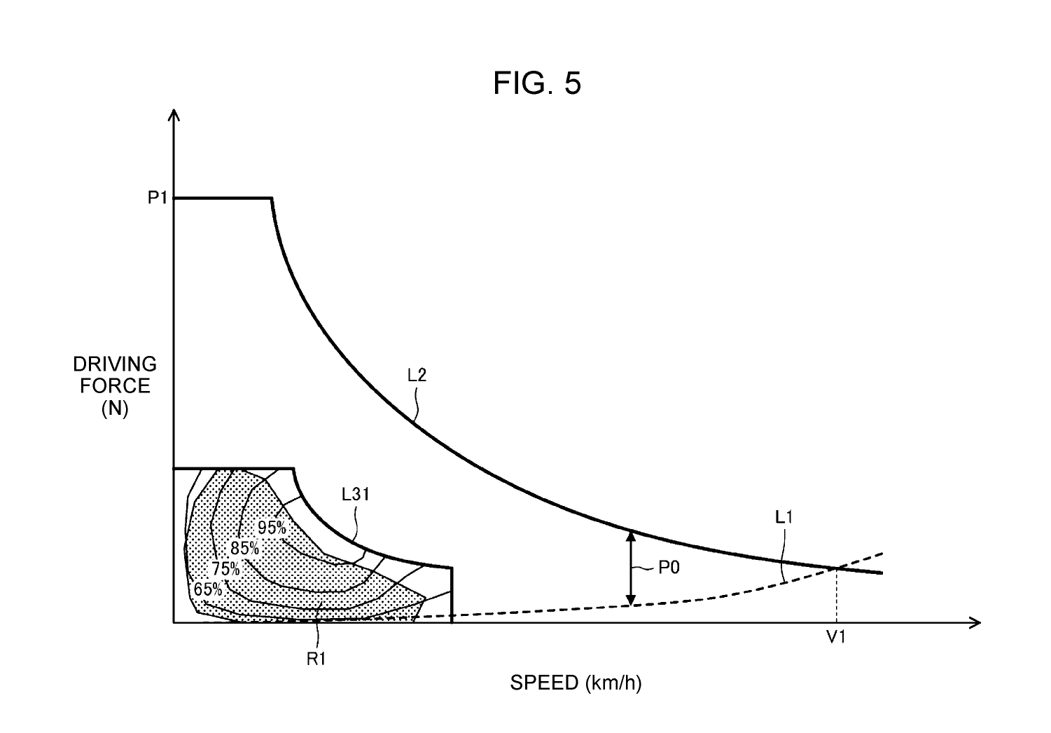

Power characteristics of first motor 31 will now be described with reference to FIG. 5. In FIG. 5, travel resistance curve L1 corresponds to travel resistance of electric vehicle 1. The travel resistance is determined based on rolling resistance, air resistance, grade resistance, and acceleration resistance of electric vehicle 1. In FIG. 5, travel resistance curve L1 corresponds to travel resistance when the grade is zero and the acceleration resistance is zero (that is, when electric vehicle 1 travels on a flat road surface at a constant speed). Required power performance curve L2 corresponds to required power performance (driving force required to vehicle drive device 10 for driving electric vehicle 1) determined based on travel resistance L1. Maximum driving force P1 corresponds to a driving force required when electric vehicle 1 starts moving from a maximum grade with a maximum load (power for driving driving wheels 2). Maximum speed V1 corresponds to a speed of electric vehicle 1 at an intersection between travel resistance curve L1 and required power performance curve L2. Excess driving force P0, which is a factor for determining acceleration performance of electric vehicle 1, corresponds to a difference between travel resistance and required power performance (specifically, a difference between a travel resistance value in travel resistance curve L1 and a required power performance value in required power performance L2 which correspond to the same speed). For example, electric vehicle 1, such as a sports car, which accelerates relatively sharply and has a relatively high maximum speed, tends to have relatively high required power performance.

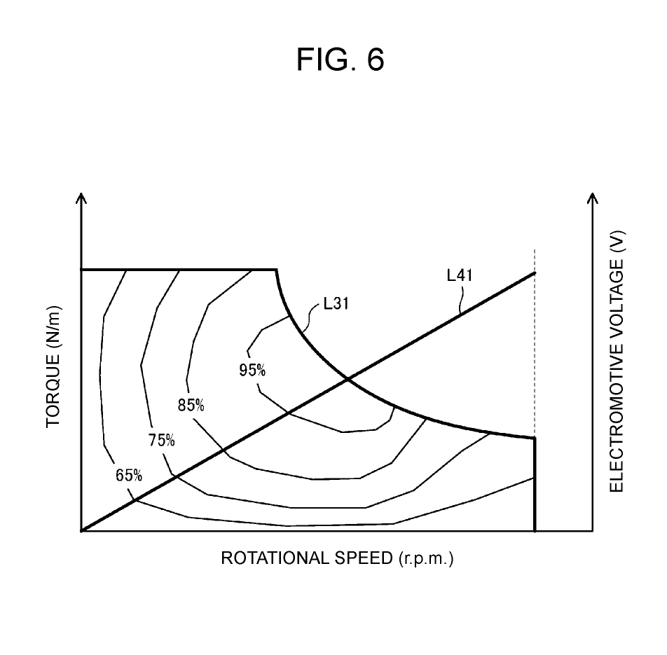

First power characteristic curve L31 corresponds to the power characteristics of first motor 31 (that is, driving force that can be generated by first motor 31). The driving force and speed in first power characteristic curve L31 are obtained by converting torque and a rotational speed in torque- rotational speed characteristics (see FIG. 6) of first motor 31 based on a gear ratio of vehicle drive device 10 and the diameter (tire diameter) of each driving wheel 2. Percentages (95%, 85%, 75%, and 65%) in FIG. 5 indicate overall efficiency of first motor 31. The overall efficiency of first motor 31 includes a copper loss and iron loss of first motor 31 and a loss of first inverter 71 connected to first motor 31.

As indicated in hatched region R1 in FIG. 5, when electric vehicle 1 travels in the medium-to-low speed low-load travel state, the rotational speed of driving wheels 2 is relatively low and the load of driving wheels 2 is relatively low. Therefore, an operating point of electric vehicle 1 tends to concentrate in a low-speed low-load region (region where the speed is relatively low and the load is relatively low). Note that first motor 31 (low-speed motor) is configured to have relatively high efficiency in the low-output region (output region where the rotational speed (speed) is less than or equal to the predetermined rotational speed threshold and the load is less than or equal to the predetermined load threshold) corresponding to the medium-to-low speed low-load travel state of electric vehicle 1. Accordingly, efficient drive of driving wheels 2 is achieved by driving driving wheels 2 with the power from first motor 31 while electric vehicle 1 travels in the medium-to-low speed low-load travel state.

### [Torque-Rotational Speed Characteristics and Electromotive Voltage Characteristics of First Motor]

Torque-rotational speed characteristics and electromotive voltage characteristics of first motor 31 will now be described with reference to FIG. 6. In the present exemplary embodiment, first motor 31 is configured with a permanent magnet motor. In FIG. 6, first power characteristic curve L31 is obtained by converting the driving force and speed into torque and a rotational speed, respectively. In other words, in FIG. 6, first power characteristic curve

L31 corresponds to the torque-rotational speed characteristics of first motor 31. Further, electromotive voltage characteristic curve L41 corresponds to an electromotive voltage of first motor 31 caused by the rotation of first motor 31.

In general, a permanent magnet motor generates a rotor magnetic field by a permanent magnet provided to a rotor, and thus, provides more excellent driving efficiency than a configuration of generating a rotor magnetic field by electric power. However, the permanent magnet motor has a tendency that, the higher its rotational speed is, the higher the electromotive voltage generated from the permanent magnet motor is, as illustrated in FIG. 6. When the electromotive voltage of the permanent magnet motor becomes equal to a voltage of a power source (for example, battery 61), electric power cannot be supplied to the permanent magnet motor from the power source via an inverter. In such a case, a magnetic field weakening control is performed to reduce the electromotive voltage of the permanent magnet motor by weakening the magnetic field of the permanent magnet of the permanent magnet motor. Thus, electric power can be supplied from the power source to the permanent magnet motor via the inverter. However, the efficiency of the permanent magnet motor is reduced due to the magnetic field of the permanent magnet being weakened.

Further, when the rotor (rotor having a permanent magnet) of the permanent magnet motor rotates, an eddy current is generated in the stator of the permanent magnet motor, and thus, an iron loss occurs. The eddy current generated in the permanent magnet motor tends to be increased with an increase in the rotational speed of the permanent magnet motor.

In vehicle drive device 10 according to the present exemplary embodiment, first motor 31 serving as a low-speed motor is a permanent magnet motor, while second motor 32 serving as a high-speed motor is a magnetless motor (such as an induction motor, a switched reluctance motor, or a synchronous reluctance motor). Therefore, even when second motor 32 rotates with the rotation of shaft 20 while electric vehicle 1 travels in the medium-to-low speed low-load travel state, an electromotive voltage or eddy current does not occur in second motor 32 which is configured with a magnetless motor. Accordingly, an increase in the electromotive voltage or generation of eddy current loss in second motor 32 can be avoided.

[Power Characteristics of Second Motor which is Configured with Magnetless Motor]

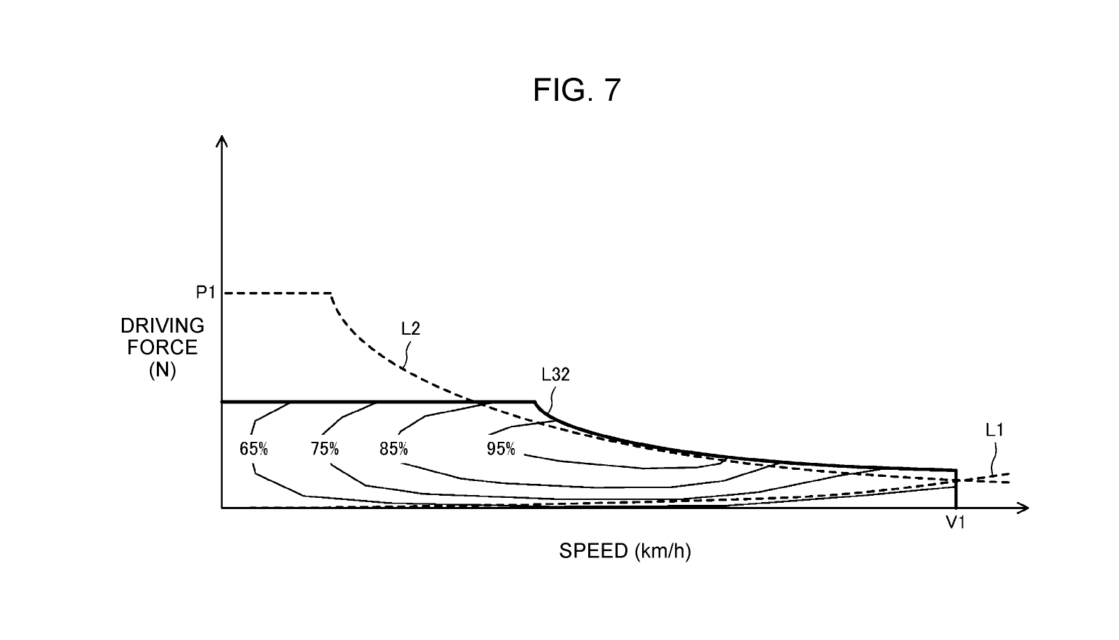

Power characteristics of second motor 32 (high-speed motor) which is configured with a magnetless motor will now be described with reference to FIG. 7. In FIG. 7, second power characteristic curve L32 corresponds to power characteristics of second motor 32 (that is, driving force that can be generated by second motor 32). Further, as described above, an electromotive voltage does not occur in second motor 32 which is configured with a magnetless motor. Therefore, second motor 32 (high-speed motor) is configured to have relatively high efficiency in the high-output region (output region where the rotational speed (speed) exceeds the predetermined rotational speed threshold) corresponding to the high-speed travel state of electric vehicle 1. Accordingly, efficient drive of driving wheels 2 is achieved by driving driving wheels 2 with the power from second motor 32 which is configured with a magnetless motor while electric vehicle 1 travels in the high-speed travel state.

### [Power Characteristics of First and Second Motors]

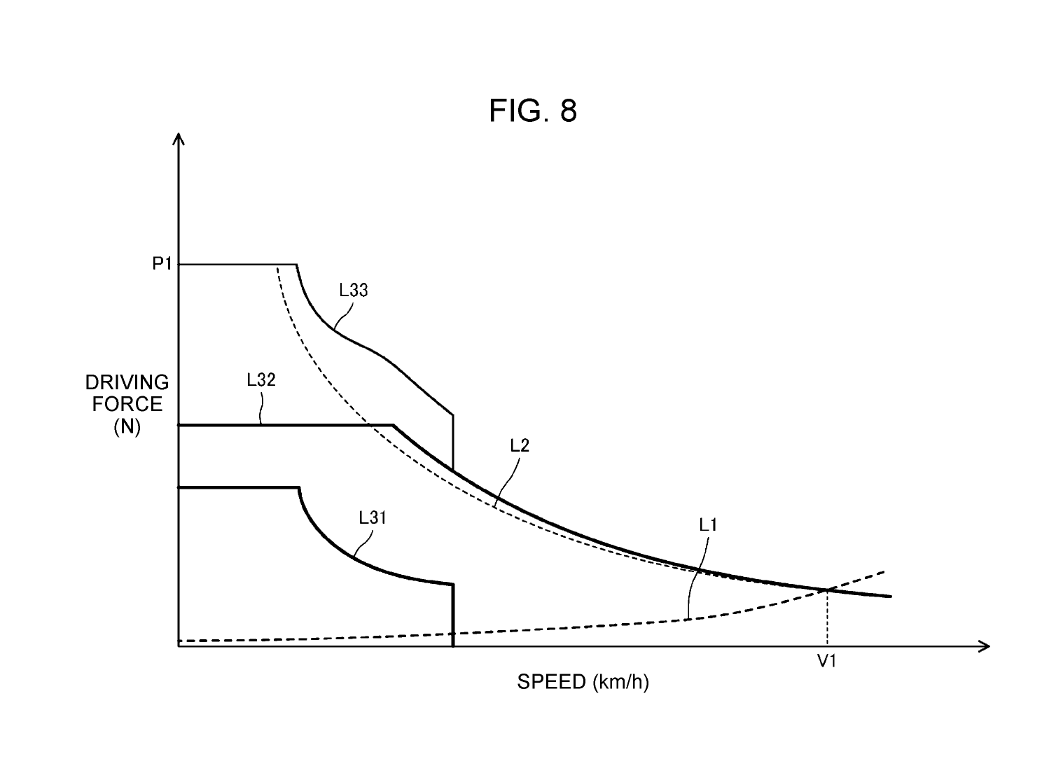

Power characteristics of first motor 31 and second motor 32 will now be described with reference to FIG. 8. In FIG. 8, second power characteristic curve L32 corresponds to power characteristics of second motor 32 (that is, driving force that can be generated by second motor 32). Total power characteristic curve L33 corresponds to a curve obtained by combining first power characteristic curve L31 and second power characteristic curve L32 (that is, a total amount of driving force that can be generated by first motor 31 and second motor 32).

As illustrated in FIG. 8, when the power characteristics of first motor 31 and the power characteristics of second motor 32 are combined, total power characteristic curve L33 exceeding required power performance curve L2 can be obtained. That is, while electric vehicle 1 travels in the medium-to-low speed high-load travel state, driving wheels 2 are driven with the power from first motor 31 and the drive of driving wheels 2 is assisted by the power from second motor 32. Accordingly, power corresponding to the medium-to-low speed high-load travel state of electric vehicle 1 can be obtained.

Further, second motor 32 (high-speed motor) is configured to have relatively high efficiency in the high-output region (output region where the rotational speed (speed) exceeds the predetermined rotational speed threshold) corresponding to the high-speed travel state of electric vehicle 1, as understood from FIGS. 7 and 8. Accordingly, efficient drive of driving wheels 2 is achieved by driving driving wheels 2 with the power from second motor 32 while electric vehicle 1 travels in the high-speed travel state.

[Power Characteristics of Second Motor which is Configured with Permanent Magnet Motor]

The example in which second motor 32 is configured with a magnetless motor has been described above. However, second motor 32 may be configured with a permanent magnet motor having high-speed specifications.

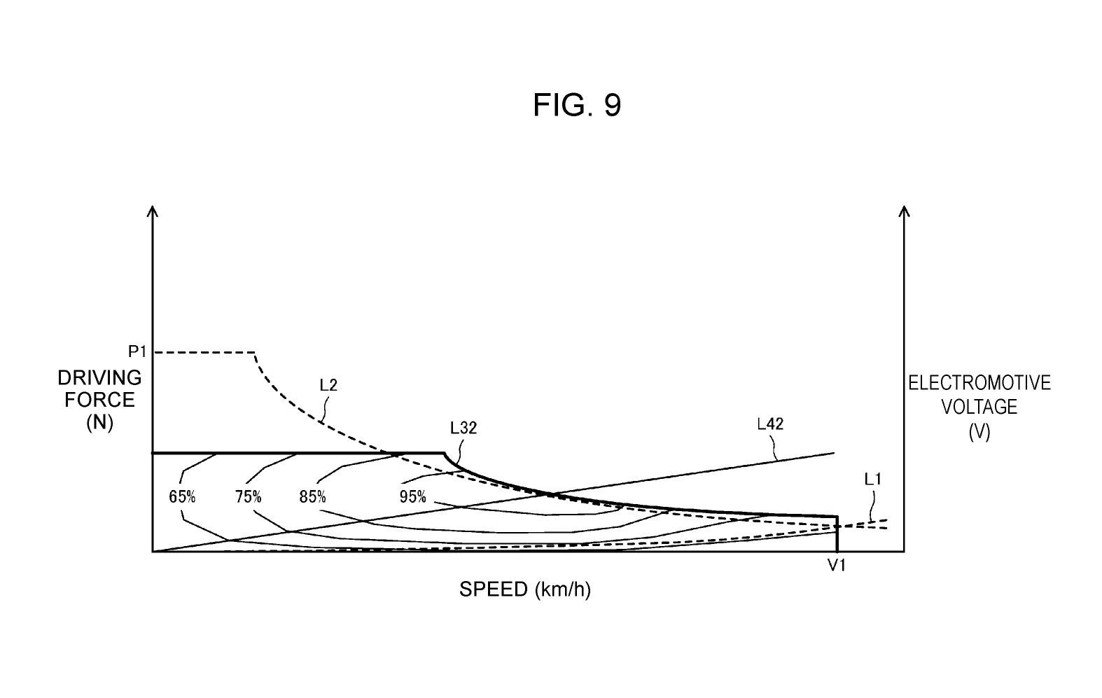

Power characteristics of second motor 32 (high-speed motor) which is configured with a permanent magnet motor having high-speed specifications will now be described with reference to FIG. 9. In FIG. 9, second power characteristic curve L32 corresponds to power characteristics of second motor 32 (that is, driving force that can be generated by second motor 32). Second electromotive voltage characteristic curve L42 corresponds to an electromotive force of second motor 32 caused by the rotation of second motor 32.

As illustrated in FIG. 9, when the permanent magnet motor having high-speed specifications is used as second motor 32, the power characteristics of second motor 32 are set such that second electromotive voltage characteristic curve L42 has a mild slope. With this, an increase in the electromotive force of the second motor with an increase in the rotational speed of second motor 32 can be reduced, whereby the frequency of execution of the magnetic field weakening control can be reduced. As described above, second motor 32 (high-speed motor) is configured to have relatively high efficiency in the high-output region (output region where the rotational speed (speed) exceeds the predetermined rotational speed threshold) corresponding to the high-speed travel state of electric vehicle 1. Therefore, efficient drive of driving wheels 2 is achieved by driving driving wheels 2 with the power from second motor 32 while electric vehicle 1 travels in the high-speed travel state.

### [Comparative Example of Motor]

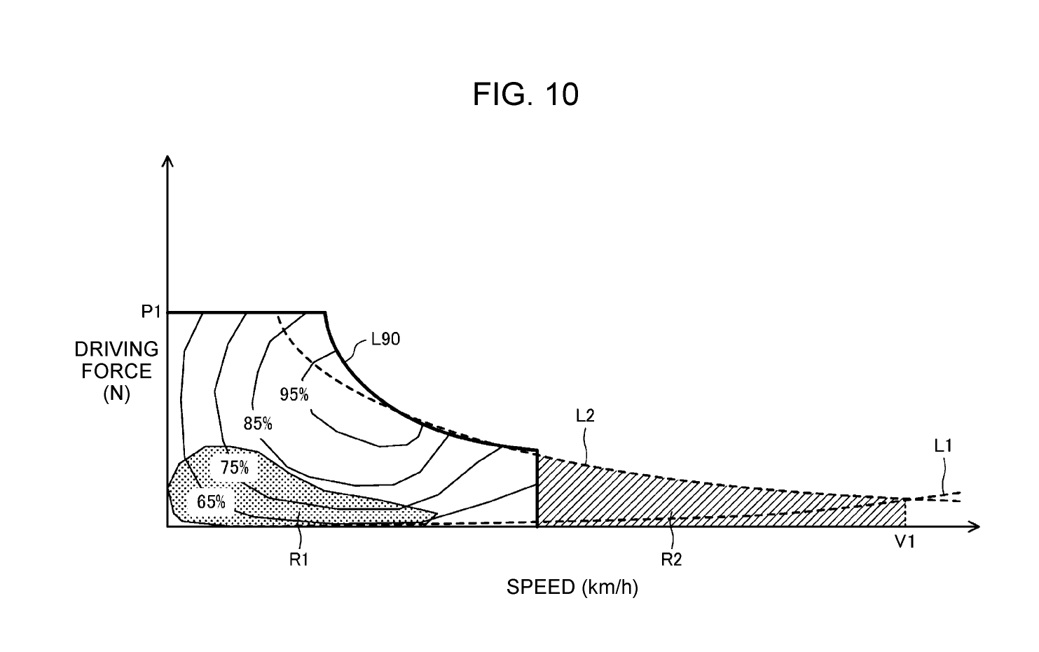

A comparative example for first motor 31 and second motor 32 will now be described with reference to FIG. 10. FIG. 10 illustrates an example in which driving wheels 2 are driven using a single motor. In FIG. 10, power characteristic curve L90 corresponds to power characteristics of a motor in the comparative example (that is, driving force that can be generated using a single motor).

In an electric vehicle, power characteristics of a single motor are commonly set such that required power performance can be satisfied by power of the single motor. However, with such setting, an operating point of the electric vehicle that travels in the medium-to-low speed low-load travel state tends to concentrate in a low-efficiency region of the motor (region where the efficiency of the motor is relatively low) as indicated by hatched region R1 in FIG. 10.

When a permanent magnet motor is used to configure the single motor, a magnetic field weakening control is performed to reduce the electromotive voltage of the motor in high-rotation region R2. Due to the execution of the magnetic field weakening control, the magnetic field of the permanent magnet in the permanent magnet motor is weakened to enable high-speed rotation of the motor. However, in the comparative example of the motor illustrated in FIG. 10, due to the magnetic field of the permanent magnet being weakened in high-speed rotation region R2, the efficiency of the motor (permanent magnet motor) is reduced.

On the other hand, in vehicle drive device 10 in the present exemplary embodiment, first motor 31 serving as a low-speed motor and second motor 32 serving as a high-speed motor are used together, whereby driving wheels 2 can be efficiently driven over a wide range from a low-speed region to a high-speed region.

### Other Exemplary Embodiments

Note that the exemplary embodiment described above is merely illustrative in nature, and is not intended to limit the scope, applications, and use of the present disclosure.

### INDUSTRIAL APPLICABILITY

As described above, the present disclosure is applicable to a vehicle drive device.

### REFERENCE MARKS IN THE DRAWINGS

1 electric vehicle

2 driving wheel

3 internal combustion engine

10 vehicle drive device

20 shaft

31 first motor

32 second motor

40 power transmission mechanism

41 gear

42 differential mechanism

43 drive shaft

50 power switching mechanism

51 first clutch member

52 second clutch member

53 third clutch member

60 control unit

61 battery

62 plug

63 charger

71 first inverter

72 second inverter

73 controller

1. A vehicle drive device that drives a driving wheel of an electric vehicle including an internal combustion engine, the vehicle drive device comprising:
a shaft;
a first motor;
a second motor connected to the shaft;
a power transmission mechanism configured to transmit power from the shaft and power from the second motor to the driving wheel; and
a power switching mechanism that is connected to the first motor, the shaft, and the internal combustion engine, and has only three states which are: a first state where power transmission between the first motor and the shaft is allowed, while power transmission between the first motor and the internal combustion engine is inhibited; a second state where power transmission between the first motor and the shaft is inhibited and power transmission between the first motor and the internal combustion engine is inhibited; and a third state where power transmission between the first motor and the internal combustion engine is allowed, while power transmission between the first motor and the shaft is inhibited, the power switching mechanism being switchable to any one of the first state, the second state, and the third state.

2. The vehicle drive device according to claim 1, wherein
the first motor is a low-speed motor,
the second motor is a high-speed motor, and
a speed range and a driving force range in power characteristics of the high-speed motor are respectively larger than a speed range and a driving force range in power characterisitics of the low-speed motor.

3. The vehicle drive device according to claim 2, wherein
the first motor is a permanent magnet motor including a permanent magnet, and
the second motor is a magnetless motor without having a permanent magnet.

4. The vehicle drive device according to claim 1, further comprising a controller that controls the first motor, the second motor, the internal combustion engine, and the power switching mechanism.

5. The vehicle drive device according to claim 4, wherein the controller sets the power switching mechanism to the first state, sets the first motor to a drive state, and sets the second motor and the internal combustion engine to a stopped state, when a rotational speed of the driving wheel is less than or equal to a predetermined rotational speed threshold and a load of the driving wheel is less than or equal to a predetermined load threshold in a travel state in which the electric vehicle is driven.

6. The vehicle drive device according to claim 4, wherein the controller sets the power switching mechanism to the first state, sets the first motor and the second motor to a drive state, and sets the internal combustion engine to a stopped state, when a rotational speed of the driving wheel is less than or equal to a predetermined rotational speed threshold and a load of the driving wheel exceeds a predetermined load threshold in a travel state in which the electric vehicle is driven.

7. The vehicle drive device according to claim 4, wherein the controller sets the power switching mechanism to the second state, sets the second motor to a drive state, and sets the first motor and the internal combustion engine to a stopped state, when a rotational speed of the driving wheel exceeds a predetermined rotational speed threshold.

8. The vehicle drive device according to claim 4, wherein the controller includes a battery that stores electric power, the controller setting the power switching mechanism to the third state, setting the internal combustion engine to a drive state, and setting the second motor to a drive state with electric power generated from the first motor, when a remaining amount of electric power stored in the battery is less than a predetermined remaining amount threshold in a travel state in which the electric vehicle is driven.

9. The vehicle drive device according to claim 8, wherein the controller is configured to store surplus electric power of the electric power generated from the first motor into the battery, the surplus electric power being not used for driving the second motor.

10. The vehicle drive device according to claim 8, wherein the controller sets the power switching mechanism to the first state, sets at least one of the first motor and the second motor to a power generation state, sets the internal combustion engine to a stopped state, and stores regenerative electric power generated from at least one of the first motor and the second motor into the battery, when the electric vehicle decelerates.

11. The vehicle drive device according to claim 4, wherein the controller sets the power switching mechanism to the first state or the second state, and sets the first motor, the second motor, and the internal combustion engine to a stopped state, when neitgher an accelerator pedal nor a brake pedal of the electric vehicle is less than a predetermined deceleration threshold.

12. An electric vehicle comprising:
a driving wheel;
an internal combustion engine; and
a vehicle drive device that is mechanically connected to the internal combustion engine and that drive the driving wheel,
wherein
the vehicle drive device is the vehicle drive device according to claim 1.
